(19) United States
(12) Patent Application Publication
(10) Pub. No.: US 2012/0281087 A1
(43) Pub. Date: Nov. 8, 2012

(54) THREE-DIMENSIONAL SCANNER FOR HAND-HELD PHONES

(75) Inventor: J. Ryan Kruse, Waltham, MA (US)

(73) Assignee: FARO TECHNOLOGIES, INC., Lake Mary, FL (US)

(21) Appl. No.: 13/460,874

(22) Filed: May 1, 2012

Related U.S. Application Data
(60) Provisional application No. 61/481,495, filed on May 2, 2011.

(51) Int. Cl. H04N 7/18

(52) U.S. Cl. 348/136; 348/E07.085

(57) ABSTRACT

A method for scanning an object in three dimensions that includes providing a handheld device and a first lens assembly, the first lens assembly removably attached to the body, the first lens assembly including a first lens and a support, the support configured to provide a fixed position for the first lens relative to the display; projecting a pattern of structured light onto the object from a display screen of the handheld device; acquiring at least one image of the structured light pattern projected onto the object using a camera integrated into the handheld device; converting each of the at least one image into digital values; and determining three-dimensional coordinates of the object based a triangulation calculation, the triangulation calculation based at least in part on the digital values and the projected pattern of the structured light.

### CROSS REFERENCE TO RELATED APPLICATIONS

The present application claims the benefit of U.S. Provisional Patent Application No. 61/481,495 filed May 2, 2011, the entire contents of which is hereby incorporated by reference.

### FIELD OF INVENTION

The present disclosure relates in general to handheld devices such as phones (e.g., “smartphones”), and more particularly to a smartphone having a screen that projects a structured light pattern out towards an object through a lens and a camera that captures or scans images of the object in three dimensions.

### BACKGROUND

Three-dimensional (3D) scanners are available for various types of uses. However, these types of scanners tend to be relatively very expensive and, thus, unavailable to the average person for purchase and use. Various inexpensive 3D scanners are now starting to show up in the marketplace. However, these 3D scanners tend to lack the type of sophistication that the more expensive scanners possess.

What is needed is a relatively very inexpensive 3D scanner that operates as an application program on a handheld device, such as a phone that has internal computational capability that supports application programs and also has a user interface with an interactive display (e.g., a smartphone such, for example, as the iPhone® or Droid™), an audio or music player such as the iPod®, or a handheld computer such as the iPad®, and which possesses relatively sophisticated applications capability and user interface, and wherein these types of handheld phone, audio, and/or computing devices are becoming rapidly popular with the general public.

### SUMMARY

According to an embodiment of the present invention, a method for scanning an object in three dimensions includes the steps of: providing a handheld device and a first lens assembly, the handheld device including a body, a display, a camera, and a processor, the display and the camera rigidly affixed to the body, the first lens assembly removably attached to the body, the first lens assembly including a first lens and a support, the support configured to provide a fixed position for the first lens relative to the display. The method also includes: projecting a pattern of structured light onto the object from a display screen of the handheld device; acquiring at least one image of the structured light pattern projected onto the object using a camera integrated into the handheld device; converting each of the at least one image into digital values; and determining three-dimensional coordinates of the object based a triangulation calculation, the triangulation calculation based at least in part on the digital values and the projected pattern of the structured light.

According to another embodiment of the present invention, a method of measuring a plurality of surface sets on an object surface with a 3D scanner that includes a handheld device and a first lens assembly, each of the surface sets being three-dimensional coordinates of a point on the object surface in a device frame of reference, each surface set including three values, the device frame of reference being associated with the handheld device. The method includes the steps of: providing the first lens assembly, the first lens assembly including a first lens and a support, the support configured to position the first lens at a fixed position in relation to a display screen, the first lens assembly configured to be removably affixed to the handheld device, providing the handheld device having a body, the display screen, a camera, and a processor, wherein the display screen and the camera are rigidly affixed to the body, wherein the display screen is configured to emit a source pattern of light, the source pattern of light located on a source plane and including a plurality of pattern elements, the first lens assembly configured to project the source pattern of light onto the object to form an object pattern of light on the object, each of the pattern elements corresponding to at least one surface set, wherein the camera includes a second lens and a first photosensitive array, the second lens configured to image the object pattern of light onto the first photosensitive array as an image pattern of light, the first photosensitive array including camera pixels, the first photosensitive array configured to produce, for each camera pixel, a corresponding pixel digital value responsive to an amount of light received by the camera pixel from the image pattern of light; wherein the processor is configured to select the source pattern of light and to determine the plurality of surface sets, each of the surface sets based at least in part on the pixel digital values and the source pattern of light. The method also includes: attaching the lens assembly to the handheld device; selecting the source pattern of light; projecting the source pattern of light onto the object to produce the object pattern of light; imaging the object pattern of light onto the first photosensitive array to obtain the image pattern of light; obtaining the pixel digital values for the image pattern of light; determining the plurality of surface sets corresponding to the plurality of pattern elements; and saving the surface sets.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1A is a not-to-scale perspective representation of a smartphone and lens projecting a structured light pattern onto an object;

FIGS. 1B-D are schematic representations of display images in accordance with an embodiment of the present invention;

FIGS. 1E and 1F are side and front views of lens and standoff elements in accordance with an embodiment of the present invention;

FIG. 1G is a schematic representation of the projection of light from a smartphone display onto an object in accordance with an embodiment of the present invention;

FIG. 2 is a flowchart of steps taken by the 3D scanner of FIGS. 1A-G in implementing a scan procedure according to embodiments of the present invention;

FIG. 3 includes several views of various types of exemplary structured light patterns that may be utilized with embodiments of the 3D scanner of the present invention;

FIG. 4 is a block diagram illustrating the principles of triangulation according to an embodiment of the present invention;

FIG. 5 is a flow chart showing steps in a method according to an embodiment of the present invention; and

FIG. 6 is a flow chart showing steps in a method according to an embodiment of the present invention.

### DETAILED DESCRIPTION

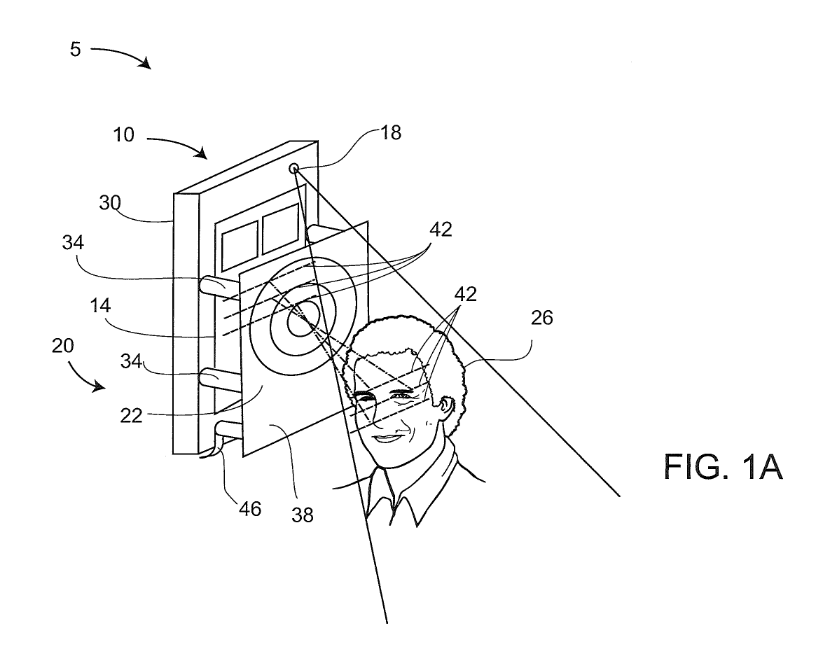

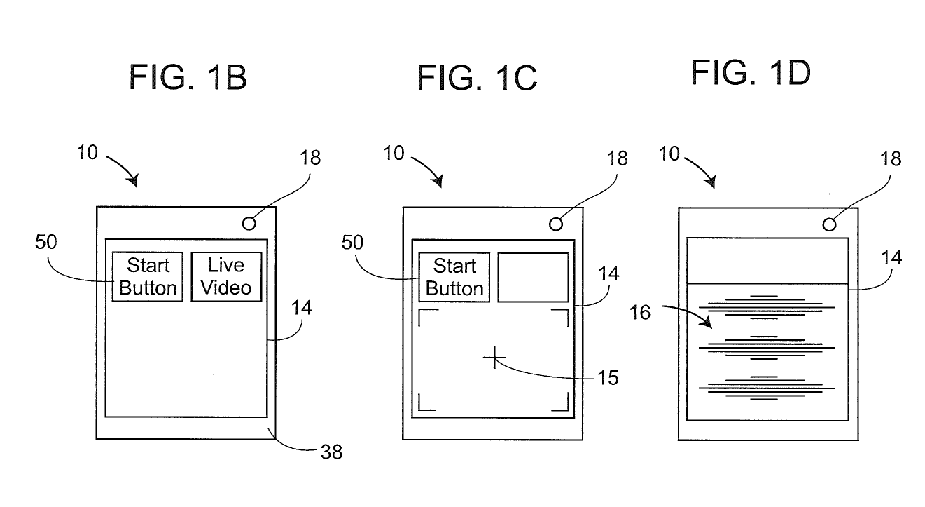

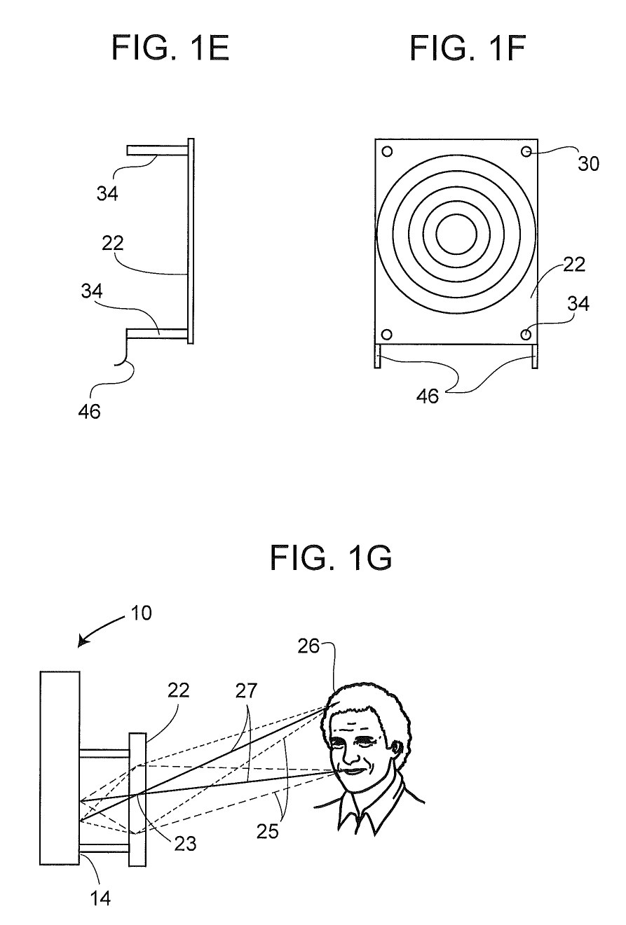

Referring to FIGS. 1A-D, in an exemplary embodiment of the present invention, a 3D scanner includes a smartphone 10 and a lens assembly 20. In an embodiment, the smartphone 10 has a relatively large front-facing display screen 14 and a front facing camera 18. The lens assembly 20 includes a lens 22 and a support 34. As shown in FIGS. 1A and 1G, the lens 22 (in this example a Fresnel lens) is used to project an image from the phone's display 14 onto an object 26 (in this example a face of a human being). The lens 22 may only cover a portion of the phone's display screen 14. The lens 22 is spaced a fixed distance from a camera frame 30 with a support 34, which may include for example standoffs or spacers. The support 34 sets the proper distance between lens 22 and the phone display 14 for projection of the structured light pattern 42 onto the object 26. In an embodiment, the support is placed in contact with a surface of the smartphone. In another embodiment, the support is placed in contact with a case that holds the smartphone. In a third embodiment, the support is integrated into the lens assembly, the support configured to be folded down for insertion into slots or holes in a case that surrounds the smartphone. In an embodiment, the case and support legs are made of plastic, the support legs being made of stiff plastic elements to provide consistent positioning of the lens in relation to the display. Because the lens assembly construction, it is suitable for use, possible with minor adaptations, for use with almost any model or smartphone.

As shown in FIGS. 1A, 1E, and 1F, the lens assembly may also include “lips” 46 that go around the edge of the phone 10 to better “grab” or attach to the phone 10. This will allow the lens assembly to be repeatably positioned with respect to the display 14 and the camera 18. Repeatable positioning will increase the accuracy of the point cloud data of the object 26 that is captured by the camera 18. The lens assembly may be removable. FIGS. 1F and 1G show side and front views of an embodiment having a support in the form of standoffs 34 and a lens 22 in the form of a Fresnel lens. A Fresnel lens is a type of lens that focuses light by means of a pattern impressed onto a nearly flat piece of plastic or glass. The solid lines 27 of FIG. 1G represent projections of light patterns from the display through the lens perspective center 23 onto the object 26. The dashed lines represent regions over which the lens collects light in sending it to the object.

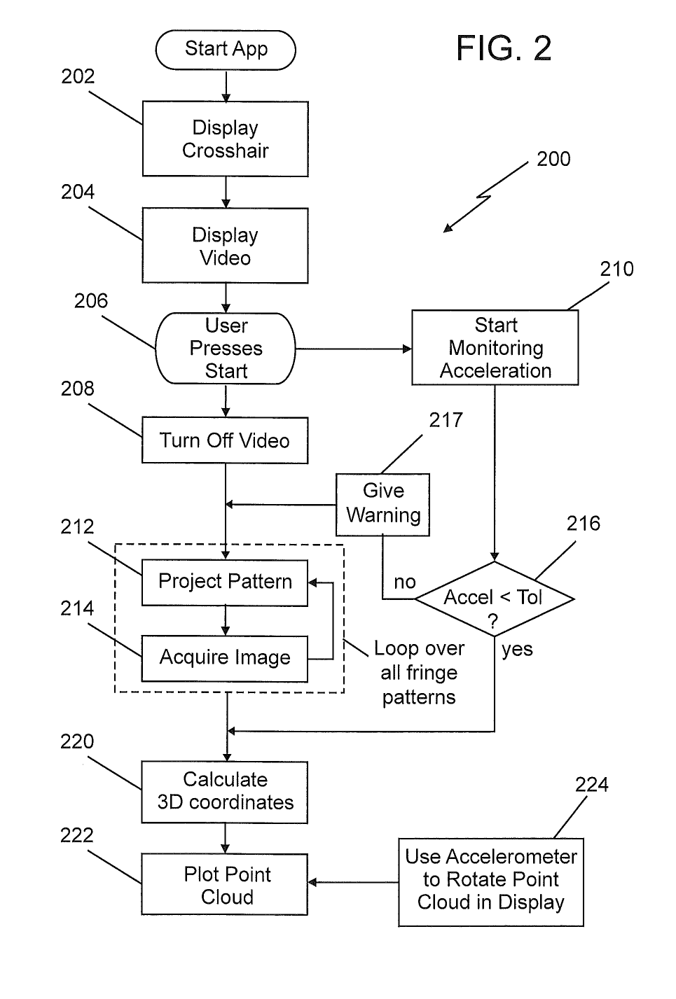

Referring also to the flowchart 200 of FIG. 2, use of the device of FIGS. 1A-1G may occur in three general operations. The steps in the flowchart 200 of FIG. 2 may be implemented in software stored on the phone 10. First is a setup operation 202 and 204. The live feed from the front facing camera 18 may be displayed on a subsection or portion of the display screen 14 (not covered by the lens 22). The region of the display screen 14 covered by the lens 22 may show a crosshair pattern 15 of FIG. 1C in a step 202 in FIG. 2. This step in the procedure may be under the direction of a processor within the phone 10 or a processor located elsewhere, for example, in an external computer in communication with the phone. The user may adjust the position of the phone 10 so that the crosshair pattern falls on the desired object 26 and the video is displayed on the screen 14 in a step 204.

In general, the remaining steps of the procedure 200 may be under the general supervision and computation of a processor (not shown) within the phone 10, a processor located in an external computer, or a combination of the two. These processors are capable of providing directions that indicate steps to be taken by an operator, providing a desired pattern on the display 14, collecting digital values for images captured by the camera 18, processing the digital values to obtain three-dimensional coordinates, and other functions.

The second operation is measurement, which includes steps 206, 208, 210, 212, 214, 216, and 217. To begin this measurement step, the user in a step 206 may press a button, which may be a “start” button 50 located on the phone display 14 or on its touchscreen. The button may also be located on the side of the phone 10 (e.g., the volume buttons). In a step 208 the software may stop displaying the live image and blank the portion of the phone's display 14 that was not covered by the lens 22 (to reduce ambient light). In an optional step 210, the software may also start monitoring the other sensors (e.g., accelerometer) on the phone 10. A pattern 16 of FIG. 1D is displayed under the lens assembly and projected onto the object in a step 212. The front facing camera 18 may then acquire an image (or multiple images) in a step 214 and store it as a collection of digital values. The pattern can change multiple times and new images acquired. After (or during) acquisition, the phone sensors can be used to determine health of the measurement in a step 216. For example, if the accelerometer recorded excessive vibration (the “acceleration<tolerance=no” condition in FIG. 2) during the measurement a warning can be given in a step 217 and a re-measurement started.

The third general operation is calculation of the results, which includes steps 220, 222, and 224. The software may analyze the stored images to determine three-dimensional coordinates in a step 220. The method used depends on the patterns used, as discussed hereinbelow, but generally depends on a triangulation calculation based at least in part on the projected pattern of light and on the stored digital values (obtained from the acquired images). In an embodiment, the resulting 3D coordinates are XYZ values for each pixel of the camera. A collection of 3D points is often referred to as a “point cloud.” Filtering can be applied to remove bad points from within the point cloud. The color of the object at points corresponding to each pixel can also be determined if the front facing camera 18 is a color camera. The point cloud may be displayed on the phone's screen 14 in a step 222. The point cloud can be inspected on a display by zooming, panning, and rotating. This view of the point cloud can be controlled by the touchscreen or by orientation changes of the phone (e.g., measured using the accelerometer in a step 224).

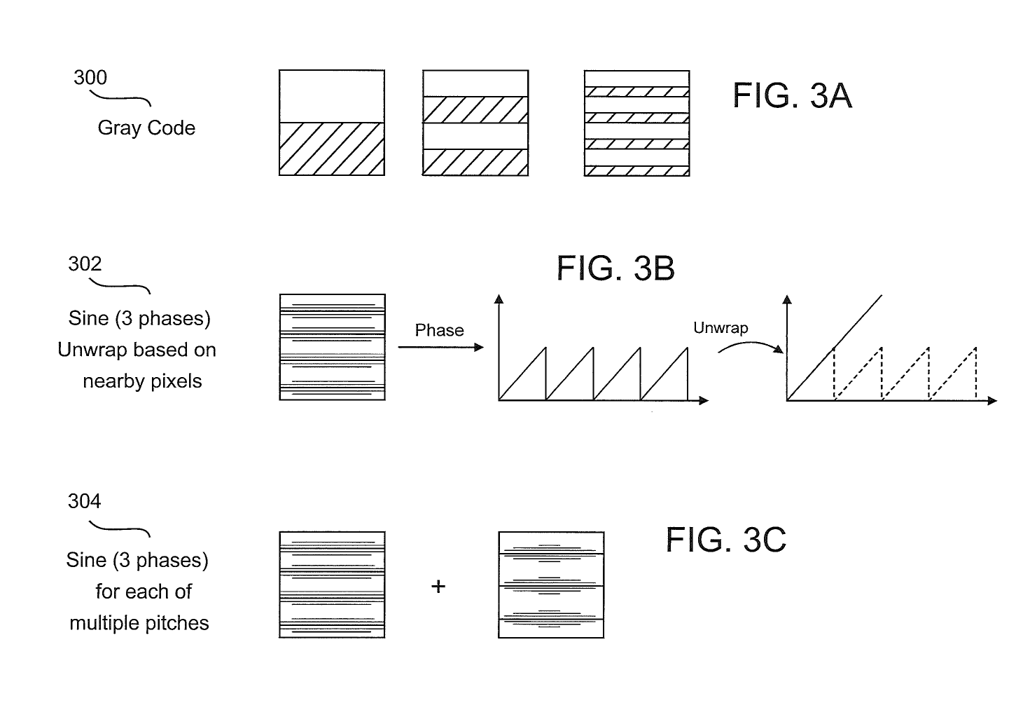

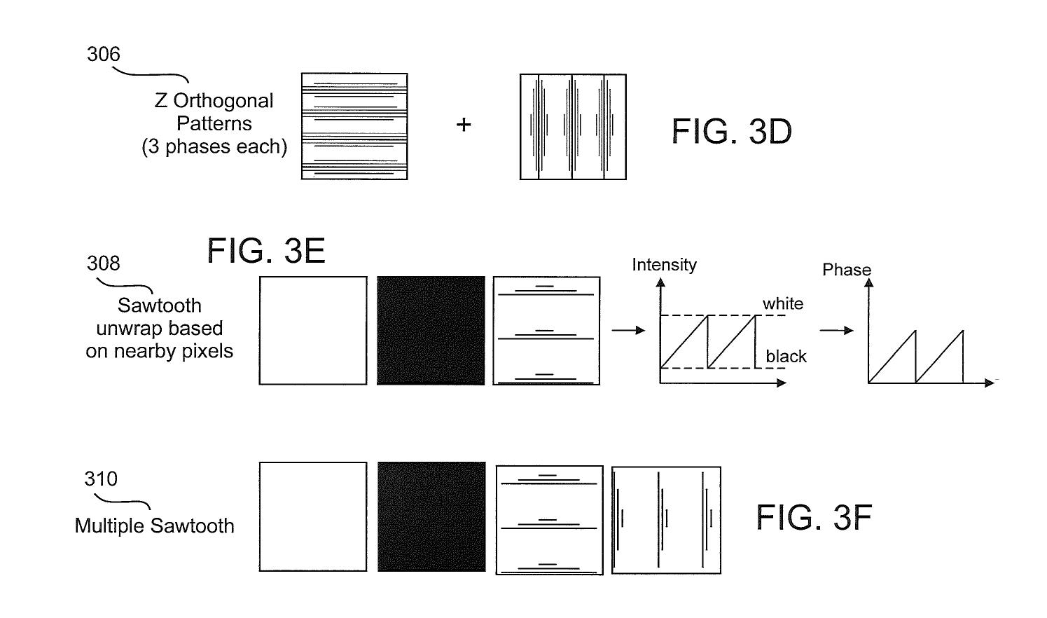

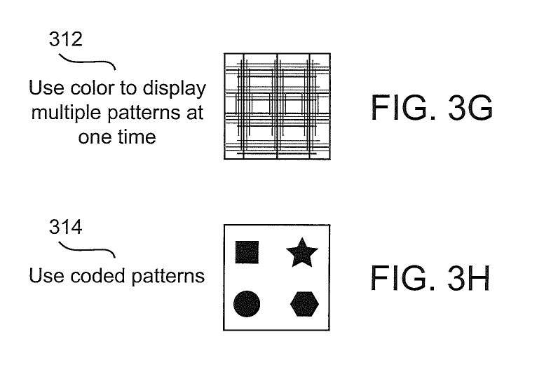

The phone's display screen 14 in modern smartphones 10 is relatively flexible, allowing many possible structured light patterns. Referring to FIGS. 3A-H, possibilities include: (A) Graycode 300: White and black lines are projected onto an object. Subsequent patterns have smaller and smaller pitch. Based on the patterns observed by a camera pixel, knowledge is obtained about the corresponding projection position on the display. By matching the projection angles and the camera angles, a triangle may be constructed that enables the distance from the smartphone to the object point to be determined. (B) Phase Shifting Interferometry (PSI) 302 using a sine pattern: A series of sinusoidal patterns are projected, each having a different phase. At each pixel, the optical power is recorded for each of the different sinusoidal patterns. This collection of sinusoidal powers is used to determine a phase for the sinusoidal pattern—in other words, the position on the sinusoidal pattern being received by a particular camera pixel. Because the projected pattern is known, the pattern observed by a camera pixel is indicative of the distance to that point. Mathematical methods that may be used to obtain the phase include use of an arctangent function, use of a look-up table, or use of a best-fit method. These methods are known to those of ordinary skill in the art. In most cases, multiple sinusoidal patterns (multiple fringes) are projected, and a method is needed to remove the ambiguity in the particular line that is being observed by a particular camera pixel. With the present method, a way to do this—in other words to “unwrap” the phase (to obtain a range of phase angles that exceeds 360 degrees)—is to note the discontinuities in the phase of adjacent pixels (for example, shifts from nearly 360 degrees to slightly more than 0 degrees and to unwrap at those points). This method is only practical if the surface being viewed is relatively smooth with no large discontinuities. (C) PSI with Multiple Pitches 304: This method is the same as method (B) hereinabove except that a plurality of pitches (periods) are provided for sinusoidal patterns. By comparing the phases measured for the sinusoids having different pitches, it is possible to separate different sinusoidal fringes, thereby enabling unwrapping of the phase. (D) PSI with Orthogonal Patterns 306: This is like PSI except the sinusoidal pattern is rotated by 90 degrees and then projected (with multiple phases) a second time. Phase is unwrapped by comparing XYZ coordinates for the two patterns. The integer part of the phase is calculated so the coordinates match. (E, F) Sawtooth Pattern 308 (E) and multiple sawtooth patterns 310 (F): With these methods, a pattern having brightness levels varying as a sawtooth pattern having a continuous gradation of gray levels from black to white (in one dimension) is projected onto the object. In addition, to provide a reference, a black (no light) and white (full light) may be projected onto the object and the resulting image captured by the camera. Multiple sawtooth patterns may be projected. The phase is calculated by measuring the level detected by each pixel (compared to white and black). The pattern is unwrapped as in the methods described hereinabove. (G) Color 312: Different colors are projected to encode multiple patterns in each image. For example, the sawtooth could have one pitch in red and a second pitch in green. The white and black patterns would be the same for both pitches. (H) Coded pattern 314: A pattern having coded features, that is, features that may be identified when viewed in the image captured by the camera, is projected onto an object. The direction of projection of each identifiable feature is known, and so by comparing the location on the photosensitive array of the camera of the identifiable feature, a triangle may be constructed to determine the distance from the handheld device to the object point. Variations of this method may also be used in which the identification of the feature is aided by the alignment of the features in relation to epipolar lines in the projector plane, explained hereinbelow.

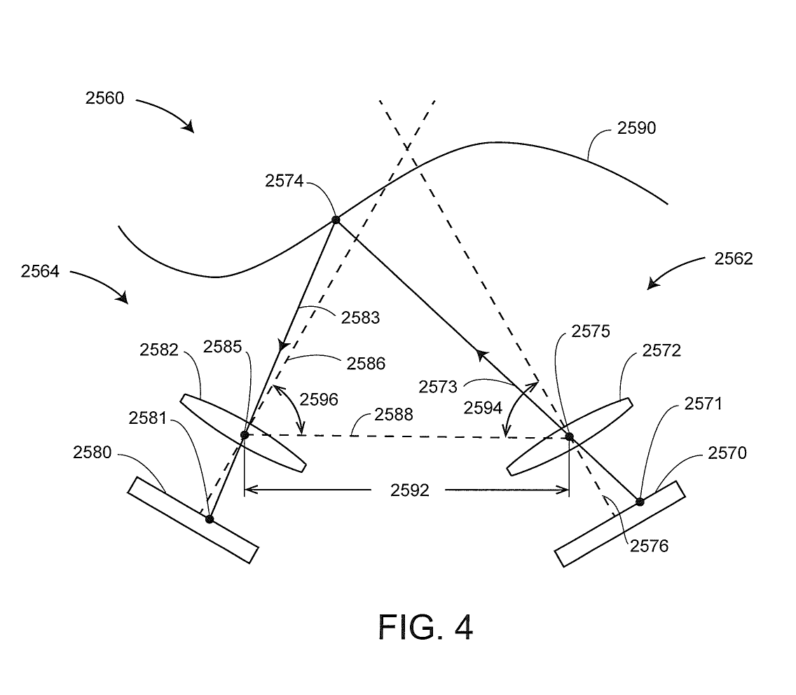

The principles of triangulation relevant for the methods described hereinabove are now described in more detail. A more complete explanation of the principles of triangulation is given with reference to the system 2560 of FIG. 4. The system 2560 includes a projector 2562 and a camera 2564. The projector 2562 includes a source pattern of light 2570 lying on a source plane and a projector lens 2572. In this case, the source pattern of light is emitted by the display screen 14. The projector lens may include several lens elements. The projector lens has a lens perspective center 2575 and a projector optical axis 2576. The ray of light 2573 travels from a point 2571 on the source pattern of light through the lens perspective center onto the object 2590, which it intercepts at a point 2574.

The camera 2564 includes a camera lens 2582 and a photosensitive array 2580. The camera lens 2582 has a lens perspective center 2585 and an optical axis 2586. A ray of light 2583 travels from the object point 2574 through the camera perspective center 2585 and intercepts the photosensitive array 2580 at point 2581.

The line segment that connects the perspective centers is the baseline 2588. The length of the baseline is called the baseline length 2592. The angle between the projector optical axis and the baseline is the baseline projector angle 2594. The angle between the camera optical axis 2583 and the baseline is the baseline camera angle 2596. If a point on the source pattern of light 2570 is known to correspond to a point on the photosensitive array 2581, then it is possible using the baseline length, baseline projector angle, and baseline camera angle to determine the sides of the triangle connecting the points 2585, 2574, and 2575, and hence determine the surface coordinates of points on the surface of object 2590 relative to the frame of reference of the measurement system 2560. To do this, the angles of the sides of the small triangle between the projector lens 2572 and the source pattern of light 2570 are found using the known distance between the lens 2572 and plane 2570 and the distance between the point 2571 and the intersection of the optical axis 2576 with the plane 2570. These small angles are added or subtracted from the larger angles 2596 and 2594 as appropriate to obtain the desired angles of the triangle. It will be clear to one of ordinary skill in the art that equivalent mathematical methods can be used to find the lengths of the sides of the triangle 2574-2585-2575 or that other related triangles may be used to obtain the desired coordinates of the surface of object 2590.

Although the triangulation method described here is well known, some additional technical information is given hereinbelow for completeness. Each lens system has an entrance pupil and an exit pupil. The entrance pupil is the point from which the light appears to emerge, when considered from the point of view of first-order optics. The exit pupil is the point from which light appears to emerge in traveling from the lens system to the photosensitive array. For a multi-element lens system, the entrance pupil and exit pupil do not necessarily coincide, and the angles of rays with respect to the entrance pupil and exit pupil are not necessarily the same. However, the model can be simplified by considering the perspective center to be the entrance pupil of the lens and then adjusting the distance from the lens to the source or image plane so that rays continue to travel along straight lines to intercept the source or image plane. In this way, the simple and widely used model shown in FIG. 4 is obtained. It should be understood that this description provides a good first order approximation of the behavior of the light but that additional fine corrections can be made to account for lens aberrations that can cause the rays to be slightly displaced relative to positions calculated using the model of FIG. 4. Although the baseline length, the baseline projector angle, and the baseline camera angle are generally used, it should be understood that saying that these quantities are required does not exclude the possibility that other similar but slightly different formulations may be applied without loss of generality in the description given herein.

When using a six-DOF scanner, several types of scan patterns may be used, and it may be advantageous to combine different types to obtain the best performance in the least time. For example, in an embodiment, a fast measurement method uses a two-dimensional coded pattern in which three-dimensional coordinate data may be obtained in a single shot. In a method using coded patterns, different characters, different shapes, different thicknesses or sizes, or different colors, for example, may be used to provide distinctive elements, also known as coded elements or coded features, as discussed with reference to FIG. 3H. Such features may be used to enable the matching of the point 2571 to the point 2581. A coded feature on the source pattern of light 2570 may be identified on the photosensitive array 2580.

A technique that may be used to simplify the matching of coded features is the use of epipolar lines. Epipolar lines are mathematical lines formed by the intersection of epipolar planes and the source plane 2570 or the image plane 2580. An epipolar plane is any plane that passes through the projector perspective center and the camera perspective center. The epipolar lines on the source plane and image plane may be parallel in some special cases, but in general are not parallel. An aspect of epipolar lines is that a given epipolar line on the projector plane has a corresponding epipolar line on the image plane. Hence, any particular pattern known on an epipolar line in the projector plane may be immediately observed and evaluated in the image plane. For example, if a coded pattern is placed along an epipolar line in the projector plane, then the spacing between coded elements in the image plane may be determined using the values read out by pixels of the photosensitive array 2580 and this information used to determine the three-dimensional coordinates of an object point 2574. It is also possible to tilt coded patterns at a known angle with respect to an epipolar line and efficiently extract object surface coordinates.

An advantage of using coded patterns is that three-dimensional coordinates for object surface points can be quickly obtained. However, in most cases, a sequential structured light approach, such as the sinusoidal phase-shift (PSI) approach discussed above, will give more accurate results. Therefore, the user may advantageously choose to measure certain objects or certain object areas or features using different projection methods according to the accuracy desired. By using a programmable source pattern of light, such a selection may easily be made.

The projector 2562 (display screen 14) may project a two dimensional pattern of light, which is sometimes called structured light. Such light emerges from the projector lens perspective center and travels in an expanding pattern outward until it intersects the object 2590. Examples of this type of pattern are the coded pattern and the periodic pattern, both discussed hereinabove. The projector 2562 may alternatively project a one-dimensional pattern of light. Such projectors are sometimes referred to as laser line probes or laser line scanners. Although the line projected with this type of scanner has width and a shape (for example, it may have a Gaussian beam profile in cross section), the information it contains for the purpose of determining the shape of an object is one dimensional. So a line emitted by a laser line scanner intersects an object in a linear projection. The illuminated shape traced on the object is two dimensional. In contrast, a projector that projects a two-dimensional pattern of light creates an illuminated shape on the object that is three dimensional. One way to make the distinction between the laser line scanner and the structured light scanner is to define the structured light scanner as a type of scanner that contains at least three non-collinear pattern elements. For the case of a two-dimensional pattern that projects a coded pattern of light, the three non-collinear pattern elements are recognizable because of their codes, and since they are projected in two dimensions, the at least three pattern elements must be non-collinear. For the case of the periodic pattern, such as the sinusoidally repeating pattern, each sinusoidal period represents a plurality of pattern elements. Since there is a multiplicity of periodic patterns in two dimensions, the pattern elements must be non-collinear. In contrast, for the case of the laser line scanner that emits a line of light, all of the pattern elements lie on a straight line. Although the line has width and the tail of the line cross section may have less optical power than the peak of the signal, these aspects of the line are not evaluated separately in finding surface coordinates of an object and therefore do not represent separate pattern elements. Although the line may contain multiple pattern elements, these pattern elements are collinear.

A smartphone and lens assembly may be moved as a unit in relation to an object to be scanned. In an embodiment, the smartphone and lens assembly is held in a user's hand and moved in front of the object. In an embodiment, the three-dimensional coordinates captured during the movement are “painted” onto a display as the movement is made. The display may be the smartphone display or a separate display. In another embodiment, the object is placed on a rotating turntable so that the smartphone and lens assembly may capture the 3D coordinates of the object from all directions. In another embodiment, the smartphone and lens assembly are placed on a rotating turntable and are used to capture the three-dimensional coordinates of surfaces surrounding the smartphone.

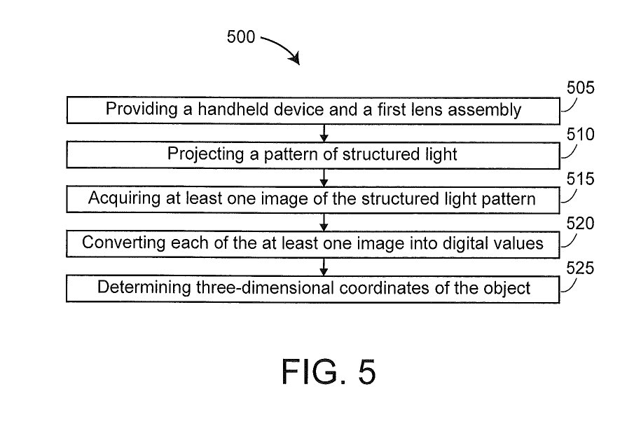

FIG. 5 is a flow chart for a method 500 for scanning an object in three dimensions. A step 505 is providing a handheld device and a first lens assembly, the handheld device including a body, a display, a camera, and a processor, the display and the camera rigidly affixed to the body, the first lens assembly removably attached to the body, the first lens assembly including a first lens and a support, the support configured to provide a fixed position for the first lens relative to the display.

A step 510 is projecting a pattern of structured light onto the object from a display screen of the handheld device.

A step 515 is acquiring at least one image of the structured light pattern projected onto the object using a camera integrated into the handheld device.

A step 520 is converting each of the at least one image into digital values.

A step 525 is determining three-dimensional coordinates of the object based a triangulation calculation, the triangulation calculation based at least in part on the digital values and the projected pattern of the structured light.

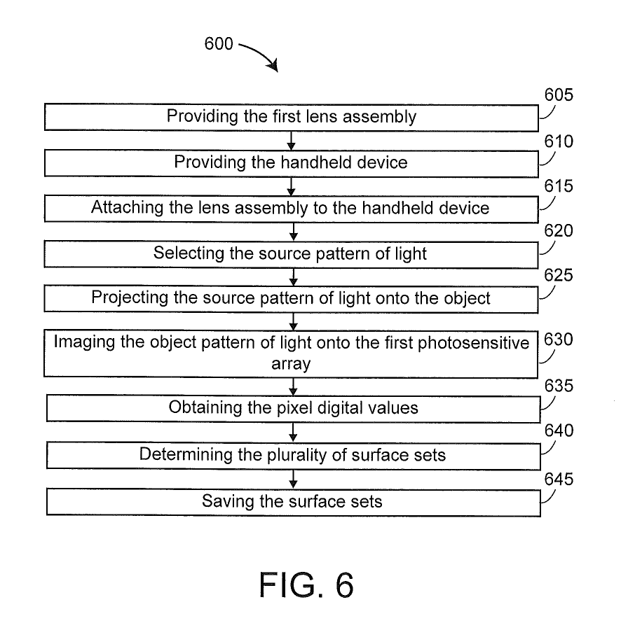

FIG. 6 is a flow chart for a method 600 of measuring a plurality of surface sets on an object surface with a 3D scanner that includes a handheld device and a first lens assembly, each of the surface sets being three-dimensional coordinates of a point on the object surface in a device frame of reference, each surface set including three values, the device frame of reference being associated with the handheld device.

The step 605 is providing the first lens assembly, the first lens assembly including a first lens and a support, the support configured to position the first lens at a fixed position in relation to a display screen, the first lens assembly configured to be removably affixed to the handheld device;

The step 610 is providing the handheld device having a body, the display screen, a camera, and a processor, wherein the display screen and the camera are rigidly affixed to the body, wherein the display screen is configured to emit a source pattern of light, the source pattern of light located on a source plane and including a plurality of pattern elements, the first lens assembly configured to project the source pattern of light onto the object to form an object pattern of light on the object, each of the pattern elements corresponding to at least one surface set, wherein the camera includes a second lens and a first photosensitive array, the second lens configured to image the object pattern of light onto the first photosensitive array as an image pattern of light, the first photosensitive array including camera pixels, the first photosensitive array configured to produce, for each camera pixel, a corresponding pixel digital value responsive to an amount of light received by the camera pixel from the image pattern of light, wherein the processor is configured to select the source pattern of light and to determine the plurality of surface sets, each of the surface sets based at least in part on the pixel digital values and the source pattern of light.

The step 615 is attaching the lens assembly to the handheld device.

The step 620 is selecting the source pattern of light.

The step 625 is projecting the source pattern of light onto the object to produce the object pattern of light.

The step 630 is imaging the object pattern of light onto the first photosensitive array to obtain the image pattern of light.

The step 635 is obtaining the pixel digital values for the image pattern of light.

The step 640 is determining the plurality of surface sets corresponding to the plurality of pattern elements.

The step 645 is saving the surface sets.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, C# or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Any flowcharts and block diagrams in the FIGURES illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While preferred embodiments have been shown and described, various modifications and substitutions may be made thereto without departing from the spirit and scope of the invention. Accordingly, it is to be understood that the present invention has been described by way of illustrations and not limitation.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for scanning an object in three dimensions, comprising the steps of:
providing a handheld device and a first lens assembly, the handheld device including a body, a display, a camera, and a processor, the display and the camera rigidly affixed to the body, the first lens assembly removably attached to the body, the first lens assembly including a first lens and a support, the support configured to provide a fixed position for the first lens relative to the display;
projecting a pattern of structured light onto the object from the display;
acquiring at least one image of the projected pattern of structured light using the camera;
converting each of the at least one image into digital values; and
determining three-dimensional coordinates of the object based on a triangulation calculation, the triangulation calculation based at least in part on the digital values and the projected pattern of the structured light.

2. The method of claim 1, wherein, in the step of providing a handheld device and a first lens assembly, the first lens is a Fresnel lens.

3. The method of claim 1, wherein:
the step of projecting a pattern of structured light onto the object includes projecting a graycode pattern of white and black lines; and
the step of determining three-dimensional coordinates includes unwrapping phase, the unwrapping of phase based at least in part on a pattern of white and black imaged by each pixel.

4. The method of claim 1, wherein:
the step of projecting a pattern of structured light onto the object includes projecting a sinusoidal pattern of light a plurality of times, each sinusoidal pattern having a different phase; and
the step of determining three-dimensional coordinates of the object includes determining three-dimensional coordinates based at least in part on use of an arctangent function.

5. The method of claim 1, wherein:
the step of projecting a pattern of structured light onto the object includes projecting a sawtooth pattern that provides a repetitive pattern of varying brightness in one dimension; and
the step of determining three-dimensional coordinates of the object includes comparing light intensity with white intensity and black intensity.

6. The method of claim 1, wherein:
the step of providing a handheld device further includes providing an accelerometer; and
the step of determining three-dimensional coordinates of the object includes providing a warning if excessive vibration is detected.

7. A method of measuring a plurality of surface sets on an object surface with a 3D scanner that includes a handheld device and a first lens assembly, each of the surface sets being three-dimensional coordinates of a point on the object surface in a device frame of reference, each surface set including three values, the device frame of reference being associated with the handheld device, the method comprising steps of:
providing the first lens assembly, the first lens assembly including a first lens and a support, the support configured to position the first lens at a fixed position in relation to a display screen, the first lens assembly configured to be removably affixed to the handheld device,
providing the handheld device having a body, the display screen, a camera, and a processor, wherein the display screen and the camera are rigidly affixed to the body,
wherein the display screen is configured to emit a source pattern of light, the source pattern of light located on a source plane and including a plurality of pattern elements, the first lens assembly configured to project the source pattern of light onto the object to form an object pattern of light on the object, each of the pattern elements corresponding to at least one surface set,
wherein the camera includes a second lens and a first photosensitive array, the second lens configured to image the object pattern of light onto the first photosensitive array as an image pattern of light, the first photosensitive array including camera pixels, the first photosensitive array configured to produce, for each camera pixel, a corresponding pixel digital value responsive to an amount of light received by the camera pixel from the image pattern of light;
wherein the processor is configured to select the source pattern of light and to determine the plurality of surface sets, each of the surface sets based at least in part on the pixel digital values and the source pattern of light;
attaching the lens assembly to the handheld device;
selecting the source pattern of light;
projecting the source pattern of light onto the object to produce the object pattern of light;
imaging the object pattern of light onto the first photosensitive array to obtain the image pattern of light;
obtaining the pixel digital values for the image pattern of light;
determining the plurality of surface sets corresponding to the plurality of pattern elements; and
saving the surface sets.

8. The method of claim 7, wherein:
the first lens has a virtual light perspective center and a projector reference axis, the projector reference axis passing through the virtual light perspective center, the projected source pattern of light appearing to emanate from the virtual light perspective center;
the camera lens has a camera lens perspective center and a camera reference axis, the camera reference axis passing through the second lens perspective center;
the 3D scanner has a baseline, a baseline length, a baseline projector angle, and a baseline camera angle, the baseline being a line segment connecting the virtual light perspective center and the camera lens perspective center, the baseline length being a length of the baseline, the baseline projector angle being an angle between the projector reference axis and the baseline, the baseline camera angle being an angle between the baseline and the camera reference axis; and
the step of providing the handheld device further includes providing the processor configured to determine the plurality of surface sets, each of the surface sets further based at least in part on the baseline length, the camera baseline angle, and the projector baseline angle.

9. The method of claim 7 wherein, in the step of providing a first lens assembly, the first lens is a Fresnel lens.

10. The method of claim 7, wherein the support is a plurality of standoff members.

11. The method of claim 8, wherein:
the step of providing the first lens assembly further includes providing the first lens configured to project the source pattern of light, the virtual light perspective center being a perspective center of the projector lens, the projector reference axis being a projector lens optical axis; and
the step of providing the handheld device further includes providing the camera reference axis being a camera lens optical axis.

12. The method of claim 9, wherein:
the step of providing a handheld device further includes providing a case, the case generally located to the exterior of the body; and
the step of providing a first lens assembly further includes providing the support configured to be affixed to the case.

13. The method of claim 12, wherein the step of providing a first lens assembly further includes providing the support configured to be folded against the lens assembly into a compact configuration.

14. The method of claim 8, wherein the step of selecting a source pattern of light includes selecting a coded pattern of light.

15. The method of claim 7, wherein the plurality of surface sets includes at least three non-collinear surface sets.
